(19) United States
(12) Patent Application Publication
(10) Pub. No.: US 2019/0042128 A1
(43) Pub. Date: Feb. 7, 2019

(54) TECHNOLOGIES DYNAMICALLY ADJUSTING THE PERFORMANCE OF A DATA STORAGE DEVICE

(71) Applicant: Intel Corporation, Santa Clara, CA (US)

(72) Inventor: Joseph David Tarango, Longmont, CO (US)

(21) Appl. No.: 16/125,870

(22) Filed: Sep. 10, 2018

(51) Int. Cl. G06F 3/06

(52) U.S. Cl. CPC G06F 3/0632; G06F 3/0673; G06F 3/0653; G06F 3/0611

(57) ABSTRACT

Technologies for dynamically adjusting the performance of a data storage device include an apparatus with a controller. The controller is configured to obtain a configuration for one or more features of a data storage device, monitor operations of the data storage device on a memory, determine, as a function of the monitored operations, an adjustment to the configuration to accelerate the performance of one or more of the operations, and apply the determined adjustment to the configuration.

### BACKGROUND

Data storage devices are typically manufactured and sold to customers with a configuration that provides a baseline level of performance for a wide range of potential workloads (e.g., a set of operations, including data access operations, performed by a compute device executing a software application). The configuration may define settings for features such as whether and how much data should be prefetched from non-volatile memory, whether and what types of encryption should be applied to data stored in the non-volatile memory, types of error correction operations to be performed on data, sizes of data blocks, buffer sizes for data access operations, and/or other settings. As such, a data storage device may incur significant latency executing superfluous code and/or performing context switches that are not needed by a particular workload.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified diagram of at least one embodiment of a system for providing dynamic adjustment of the performance of a data storage device;

FIG. 2 is a simplified block diagram of at least one embodiment of a compute device included in the system of FIG. 1;

FIG. 3 is a simplified block diagram of at least one embodiment of a data storage device included in a compute device of the system of FIG. 1; and

FIGS. 4-6 are a simplified block diagram of at least one embodiment of a method for providing dynamic performance adjustment that may be executed by the data storage device of FIG. 3.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

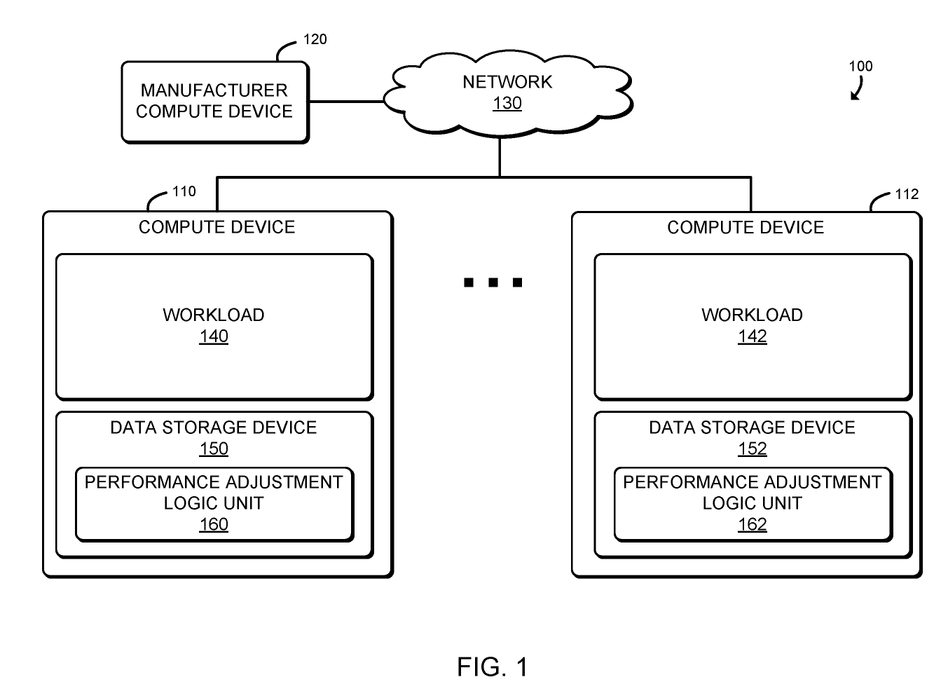

Referring now to FIG. 1, a system 100 for providing dynamic adjustment of the performance of data storage devices includes a set of compute devices 110, 112 in communication with a manufacturer compute device 120 (e.g., a compute device used by a manufacturer of the data storage devices) through a network 130. The compute devices 110, 112, in the illustrative embodiment, are located in a data center (e.g., a cloud data center) and execute workloads 140, 142 (e.g., sets of operations, such as applications, in virtual machines or containers) on behalf of a customer (not shown). The workloads 140, 142, in operation, may request data from and store data to a corresponding data storage device 150, 152 in each compute device 110, 112. In doing so, one workload (e.g., the workload 140) may request only a subset of the available data access operations that the data storage device 150 is capable of performing and/or may exhibit a particular pattern in requesting access to data available on the data storage device 150. For example, the workload 140 may utilize one of a set of available error correction algorithms and/or encryption algorithms that the data storage device 150 is capable of performing and may typically read relatively large data files (e.g., for media streaming), while the workload 142 may utilize a different set of available error correction algorithms and/or encryption algorithms that the data storage device 152 is capable of performing, and may exhibit a different pattern of data access (e.g., reading smaller data sets and writing to the data storage device 150 more frequently than the workload 140 writes to the data storage device 150).

In the illustrative embodiment, each data storage device 150, 152 includes a corresponding performance adjustment logic unit 160, 162, which may be embodied as software or circuitry (e.g., a co-processor, a microcontroller, an application specific integrated circuit (ASIC), a field programmable gate array (FPGA), etc.) configured to learn the usage patterns (e.g., requests from the corresponding workload 140, 142) and modify features of the data storage device 150, 152 to more efficiently serve the needs of the workload 140, 142. For example, each performance adjustment logic unit 160, 162 may modify executable code to disable checks that would otherwise be performed to monitor whether certain components (e.g., hardware and/or software) are functioning properly if those components are not used by the corresponding workload 140, 142 (e.g., to reduce boot times for the data storage devices 150, 152), reorganize executable code to move frequently used functions closer together in the memory of the data storage device 150, 152 to reduce the amount of time needed by a data storage controller in each corresponding data storage device 150, 152 to access and execute the executable code, relocate and/or distribute data sets within the data storage device 150, 152 to reduce latency in accessing the data sets, and enable and/or adjust data prefetching operations. As such, compared to typical data storage devices that maintain the same performance or may even slow down over time, the data storage devices 150, 152 iteratively improve their performance as they adapt to the needs of the workloads 140, 142. Further, and as described in more detail herein, the compute devices 110, 112 may provide, to the manufacturer compute device 120 (e.g., in an encrypted format), data indicative of the adjustments to the features and the corresponding performance improvements, for analysis by the manufacturer.

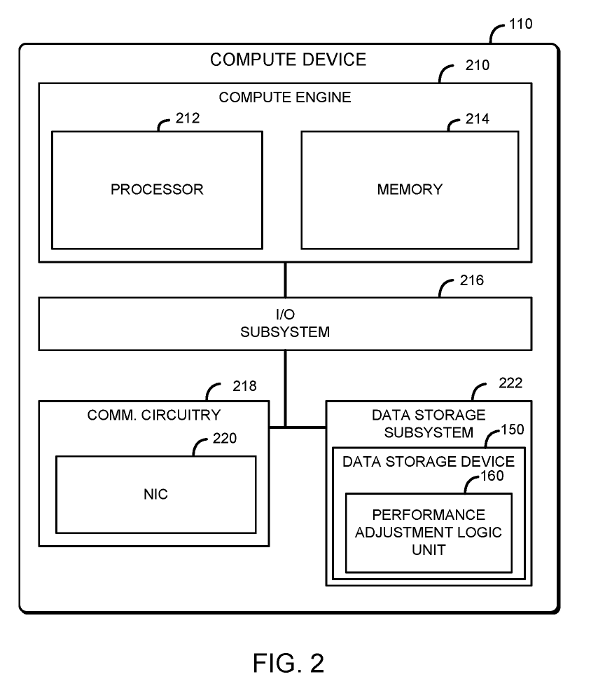

Referring now to FIG. 2, the illustrative compute device 110 includes a compute engine (also referred to herein as “compute engine circuitry”) 210, an input/output (I/O) subsystem 216, communication circuitry 218, and a data storage subsystem 222. Of course, in other embodiments, the compute device 110 may include other or additional components, such as those commonly found in a computer (e.g., a display, peripheral devices, etc.). Additionally, in some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. In the illustrative embodiment, the compute engine 210 includes or is embodied as a processor 212 and a memory 214. The processor 212 may be embodied as any type of processor capable of performing the functions described herein. For example, the processor 212 may be embodied as a multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as dynamic random access memory (DRAM) or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

In one embodiment, the memory device is a block addressable memory device, such as those based on NAND or NOR technologies. A memory device may also include a three dimensional crosspoint memory device (e.g., Intel 3D XPoint™ memory), or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product.

In some embodiments, 3D crosspoint memory (e.g., Intel 3D XPoint™ memory) may comprise a transistor-less stackable cross point architecture in which memory cells sit at the intersection of word lines and bit lines and are individually addressable and in which bit storage is based on a change in bulk resistance. In some embodiments, all or a portion of the main memory 214 may be integrated into the processor 212. In operation, the main memory 214 may store various software and data used during operation such as applications, libraries, and drivers.

The compute engine 210 is communicatively coupled to other components of the compute device 110 via the I/O subsystem 216, which may be embodied as circuitry and/or components to facilitate input/output operations with the compute engine 210 (e.g., with the processor 212 and/or the main memory 214) and other components of the compute device 110. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the compute device 110, into the compute engine 210.

The communication circuitry 218 may be embodied as any communication circuit, device, or collection thereof, capable of enabling communications over the network 130 between the compute device 110 and another compute device (e.g., the manufacturer compute device 120, etc.). The communication circuitry 218 may be configured to use any one or more communication technology (e.g., wired or wireless communications) and associated protocols (e.g., Ethernet, Bluetooth®, Wi-Fi®, WiMAX, etc.) to effect such communication.

The illustrative communication circuitry 218 includes a network interface controller (NIC) 220, which may also be referred to as a host fabric interface (HFI). The NIC 220 may be embodied as one or more add-in-boards, daughter cards, network interface cards, controller chips, chipsets, or other devices that may be used by the compute device 110 to connect with another compute device (e.g., the manufacturer compute device 120, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. In such embodiments, the local processor of the NIC 220 may be capable of performing one or more of the functions of the compute engine 210 described herein. Additionally or alternatively, in such embodiments, the local memory of the NIC 220 may be integrated into one or more components of the compute device 110 at the board level, socket level, chip level, and/or other levels.

The data storage subsystem 222 may be embodied as a set of one or more data storage devices. In the illustrative embodiment, the data storage subsystem 222 includes the data storage device 150, which may be embodied as any type of device configured for short-term or long-term storage of data such as, for example, memory devices and circuits, memory cards, hard disk drives, solid-state drives, or other data storage device. The data storage device 150 may include a system partition that stores data and firmware code for the data storage device 150 and configuration data for features of the data storage device 150. The data storage device 150 may also include one or more operating system partitions that store data files and executables for operating systems. Additionally, in the illustrative embodiment, the data storage device 150 includes the performance adjustment logic unit 160 described with reference to FIG. 1.

The compute device 112 and manufacturer compute device 120 may have components similar to those described in FIG. 2 with reference to the compute device 110. The description of those components of the compute device 110 is equally applicable to the description of components of the compute device 112 and the manufacturer compute device 120, with the exception that, in some embodiments, the manufacturer compute device 120 does not include the performance adjustment logic unit 160. Further, it should be appreciated that any of the compute devices 110, 112 and the manufacturer compute device 120 may include other components, sub-components, and devices commonly found in a computing device, which are not discussed above in reference to the compute device 110 and not discussed herein for clarity of the description.

As described above, the compute devices 110, 112 and the manufacturer compute device 120 are illustratively in communication via the network 130, which may be embodied as any type of wired or wireless communication network, including global networks (e.g., the Internet), local area networks (LANs) or wide area networks (WANs), cellular networks (e.g., Global System for Mobile Communications (GSM), 3G, Long Term Evolution (LTE), Worldwide Interoperability for Microwave Access (WiMAX), etc.), a radio area network (RAN), digital subscriber line (DSL) networks, cable networks (e.g., coaxial networks, fiber networks, etc.), or any combination thereof.

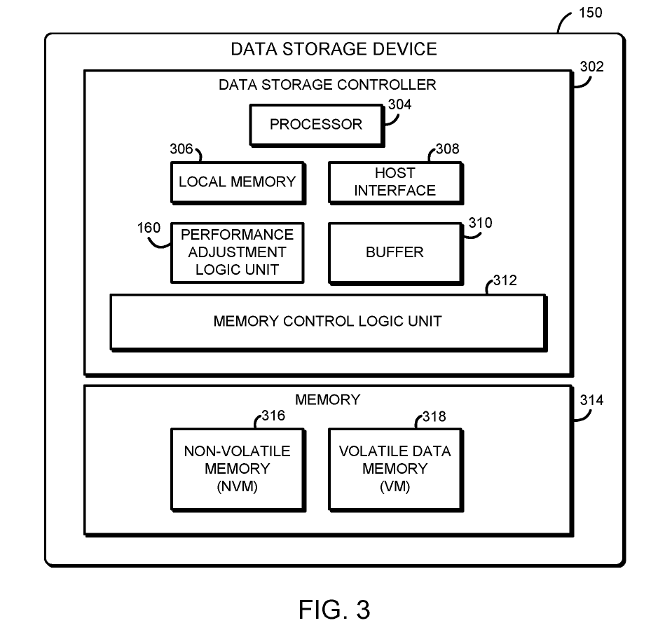

Referring now to FIG. 3, in the illustrative embodiment, the data storage device 150 includes the data storage controller 302 and a memory 314, which illustratively includes a non-volatile memory 316 and a volatile memory 318. The data storage controller 302 may be embodied as any type of control device, circuitry or collection of hardware devices capable of selectively reading from and/or writing to the memory 314 (e.g., in response to requests from a host device, such as the compute device 110) and performing related operations in the process of reading and/or writing the data (e.g., pre-fetching data before that data is requested by the host, performing error correction operations on data, encrypting or decrypting data, etc.), as well as learning the usage patterns of a workload (e.g., the workload 140) and adjusting features of the data storage device 150 to more efficiently (e.g., with lower latency) serve the needs of the workload, as described in more detail herein. In the illustrative embodiment, the data storage controller 302 includes a processor (or processing circuitry) 304, a local memory 306, a host interface 308, the performance adjustment logic unit 160, a buffer 310, and a memory control logic unit 312. In some embodiments, the processor 304, memory control logic unit 312, and the memory 306, 314 may be included in a single die or integrated circuit. Of course, the data storage controller 302 may include additional devices, circuits, and/or components commonly found in a controller of a data storage device in other embodiments.

The processor 304 may be embodied as any type of processor capable of performing the functions disclosed herein. For example, the processor 304 may be embodied as a single or multi-core processor(s), digital signal processor, microcontroller, or other processor or processing/controlling circuit. Similarly, the local memory 306 may be embodied as any type of volatile and/or non-volatile memory or data storage capable of performing the functions disclosed herein. In the illustrative embodiment, the local memory 306 stores firmware and/or instructions executable by the processor 304 to perform the described functions of the data storage controller 302. In some embodiments, the processor 304 and the local memory 306 may form a portion of a System-on-a-Chip (SoC) and be incorporated, along with other components of the data storage controller 108, onto a single integrated circuit chip.

The host interface 308 may also be embodied as any type of hardware processor, processing circuitry, input/output circuitry, and/or collection of components capable of facilitating communication of the data storage device 150 with a host device (e.g., the compute device 110) or service (e.g., the workload 140). That is, the host interface 308 embodies or establishes an interface for accessing data stored on the data storage device 150 (e.g., stored in the memory 314). To do so, the host interface 308 may be configured to use any suitable communication protocol and/or technology to facilitate communications with the data storage device 150 depending on the type of data storage device. For example, the host interface 308 may be configured to communicate with a host device or service using Serial Advanced Technology Attachment (SATA), Peripheral Component Interconnect express (PCIe), Serial Attached SCSI (SAS), Universal Serial Bus (USB), and/or other communication protocol and/or technology in some embodiments.

The buffer 310 may be embodied as volatile memory used by data storage controller 302 to temporarily store data that is being read from or written to the memory 314. The particular size of the buffer 310 may be dependent on the total storage size of the memory 314. The memory control logic unit 312 is illustratively embodied as hardware circuitry and/or devices (e.g., a processor, an ASIC, etc.) configured to control the read/write access to data at particular storage locations of the memory 314.

The non-volatile memory 316 may be embodied as any type of data storage capable of storing data in a persistent manner (even if power is interrupted to non-volatile memory 316). For example, in the illustrative embodiment, the non-volatile memory 316 is embodied as a set of multiple non-volatile memory devices. The non-volatile memory devices of the non-volatile memory 316 are illustratively embodied as NAND Flash memory devices. However, in other embodiments, the non-volatile memory 316 may be additionally or alternatively include any combination of memory devices that use chalcogenide phase change material (e.g., chalcogenide glass), three-dimensional (3D) crosspoint memory, or other types of byte-addressable, write-in-place non-volatile memory, ferroelectric transistor random-access memory (FeTRAM), nanowire-based non-volatile memory, phase change memory (PCM), memory that incorporates memristor technology, Magnetoresistive random-access memory (MRAM) or Spin Transfer Torque (STT)-MRAM. The volatile memory 318 may be embodied as any type of data storage device or devices capable of storing data while power is supplied to the volatile memory 318, similar to the memory 214 described with reference to FIG. 2. For example, in the illustrative embodiment, the volatile memory 318 is embodied as one or more dynamic random-access memory (DRAM) devices.

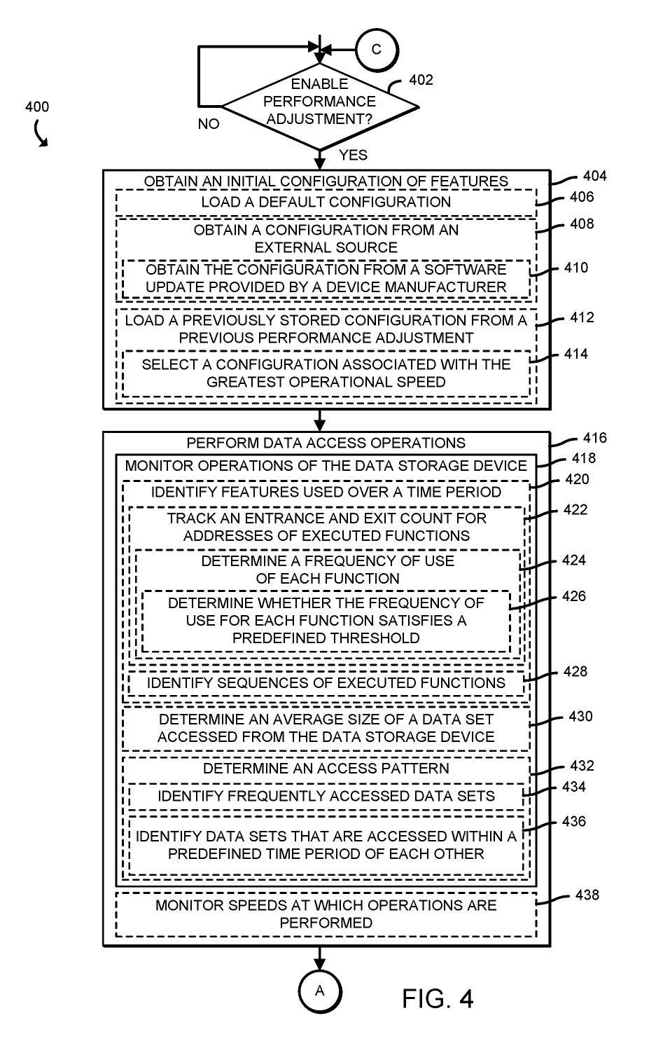

Referring now to FIG. 4, a data storage device of a compute device in the system 100 (e.g., the data storage device 150 of the compute device 110), in operation, may execute a method 400 for dynamically adjusting the performance of the data storage device 150 to more efficiently serve the needs of a workload (e.g., the workload 140) executed by the compute device 110. The method 400 begins with block 402 in which the data storage device 150 determines whether to enable dynamic performance adjustment. In the illustrative embodiment, the data storage device 150 may determine to enable dynamic performance adjustment in response to a determination that the performance adjustment logic unit 160 is present, in response to a request (e.g., from a host device, such as the compute device 110), and/or based on other criteria. Regardless, in response to a determination to enable dynamic performance adjustment, the method 400 advances to block 404, in which the data storage device 150 obtains an initial configuration of features. In doing so, and as indicated in block 406, the data storage device 150 may load a default configuration (e.g., a configuration provided to the data storage device 150 at the time of manufacture) from the memory 314.

As indicated in block 408, the data storage device 150 may obtain a configuration from an external source (e.g., from outside of the data storage device 150). For example, and as indicated in block 410, the data storage device 150 may obtain a configuration from a software update provided by a manufacturer of the data storage device 150 (e.g., a software update sent from the manufacturer compute device 120 to the compute device 110 through the network 130). Alternatively, and as indicated in block 412, the data storage device 150 may load a previously stored configuration from a previous performance adjustment (e.g., a previous execution of the method 400). In doing so, the data storage device 150 may select one configuration from a set of configurations stored in the memory 314 based on operational speed data (e.g., data indicative of measured amounts of time taken by the data storage device 150 to perform a set of data access operations under the corresponding configuration), as indicated in block 414. In doing so, in the illustrative embodiment, the data storage device 150 selects the configuration associated with the greatest operational speed.

Subsequently, in block 416, the data storage device 150 performs data access operations (e.g., reading and/or writing data sets in response to requests from the processor 212 as the compute device 110 executes the workload 140). In doing so, the data storage device 150 monitors aspects of the operations it performs, as indicated in block 418. For example, and as indicated in block 420, the data storage device 150 identifies features (e.g., available functions of the data storage device 150, such as encryption/decryption, error correction algorithms, etc.) over a time period (e.g., until the data storage device is powered down). In the illustrative embodiment, the data storage device 150 may track an entrance and exit count for addresses (e.g., in the memory 306 or 314) of functions executed by the data storage device (e.g., by the data storage controller 302), indicating the number of times each function is executed by the data storage device 150 during the time period, as indicated in block 422. As indicated in block 424, in the illustrative embodiment, the data storage device 150 determines a frequency of use of each function. Further, and as indicated in block 426, the data storage device 150 determines whether the frequency of use for each function satisfies a predefined threshold (e.g., determines which functions were executed at least once during the time period).

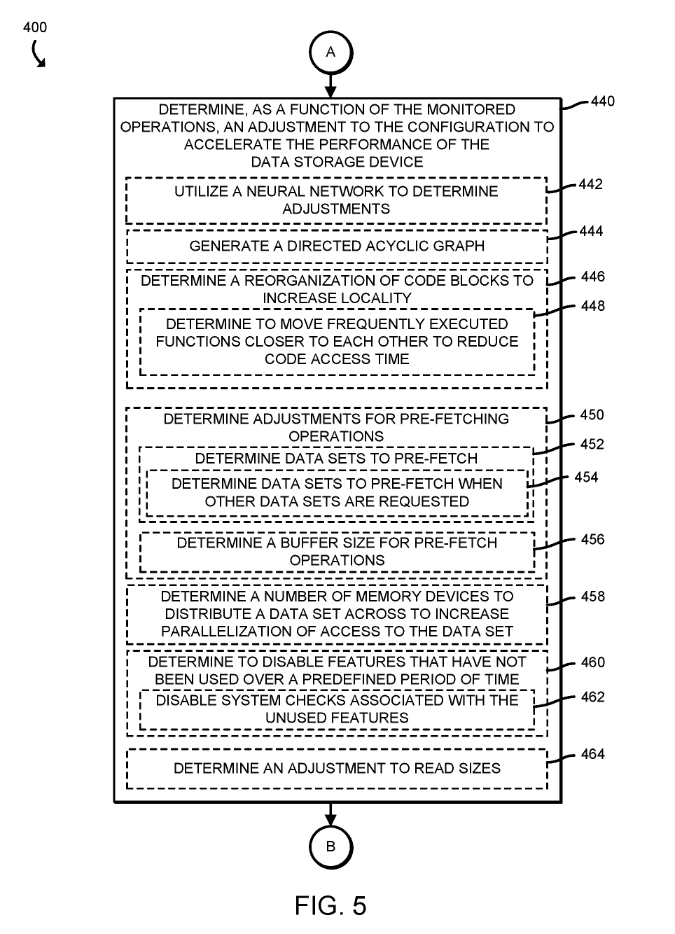

As indicated in block 428, the data storage device 150, in the illustrative embodiment, also identifies sequences (e.g., paths) of executed functions (e.g., function A is executed, then function C, then function F, then function D). In monitoring the operations, the data storage device 150 may additionally determine an average size of a data set accessed from the data storage device 150 (e.g., from the memory 314), as indicated in block 430. For example, a workload that streams data such as media files may read relatively large data sets from the memory 314 compared to a workload that performs user authentication operations (e.g., for a website). Similarly, the data storage device 150 may determine a data access pattern associated with the operations performed on behalf of the workload 140, as indicated in block 432. In doing so, the data storage device 150 may identify data sets that are accessed with a predefined frequency (e.g., at least once per second), as indicated in block 434. Additionally or alternatively, the data storage device 150 may identify data sets that are accessed within a predefined period of each other (e.g., the data storage device 150 typically accesses data set B within 10 milliseconds of accessing data set A), as indicated in block 436. Further, in the illustrative embodiment, the data storage device 150 monitors the speeds at which the operations are performed (e.g., an amount of time taken to perform each operation). The method 400 continues on in block 440 of FIG. 5, in which the data storage device 150 determines, as a function of the monitored operations (e.g., the monitored usage of the data storage device 150 by the workload 140), an adjustment to the configuration (e.g., the configuration obtained in block 404) to accelerate the performance of the data storage device 150 (e.g., to reduce the amount of time taken to perform one or more operations).

Referring now to FIG. 5, in determining the adjustment, the data storage device 150 may utilize a neural network (e.g., determine a difference between an expected set of results predicted by the neural network, such as the features of the data storage device 150 that were used and the speed at which operations were performed, and the actual monitored results, to determine adjustments to one or more settings), as indicated in block 442. The data storage device 150 may also generate a directed acyclic graph (e.g., a data structure indicating paths between nodes, which may be indicative of sequences of data sets accessed by the data storage device 150 and/or functions executed by the data storage device 150 during the time period that the operations were monitored in block 418 of FIG. 4), as indicated in block 444. The data storage device 150 may also determine a reorganization of code blocks (e.g., sets of code that define functions) to increase their locality, as indicated in block 446. For example, and as indicated in block 448, the data storage device 150 may determine to move frequently executed functions (e.g., a set of functions that were executed more than a predefined number of times) closer to each other in the memory 314 to reduce the amount of time needed by the data storage device 150 to access the code for each of those functions in the future.

The data storage device 150 may additionally or alternatively determine adjustments for data prefetching operations, as indicated in block 450. For example, the data storage device 150 may determine data sets that should be prefetched (e.g., read into a buffer before the workload 140 requests the data set(s)), as indicated in block 452. In doing so, the data storage device 150 may determine one or more data sets to prefetch when another data set has been requested by the workload 140 (e.g., because those data sets are often accessed within a relatively short period of time of each other), as indicated in block 454. Similarly, the data storage device 150 may determine a size of a buffer to be used in prefetch operations (e.g., to enable prefetching of a complete data set that is likely to be requested, rather than only a portion of that data set), as indicated in block 456. As indicated in block 458, the data storage device 150 may determine a number a memory devices (e.g., NAND devices) to distribute a data set across to increase parallelization of access to the data set (e.g., by concurrently reading parts of a total data set from different non-volatile memory devices in the non-volatile memory 318, the data storage device 150 may provide the complete data set to the workload 140 faster than if the entire data set was read from a single non-volatile memory device).

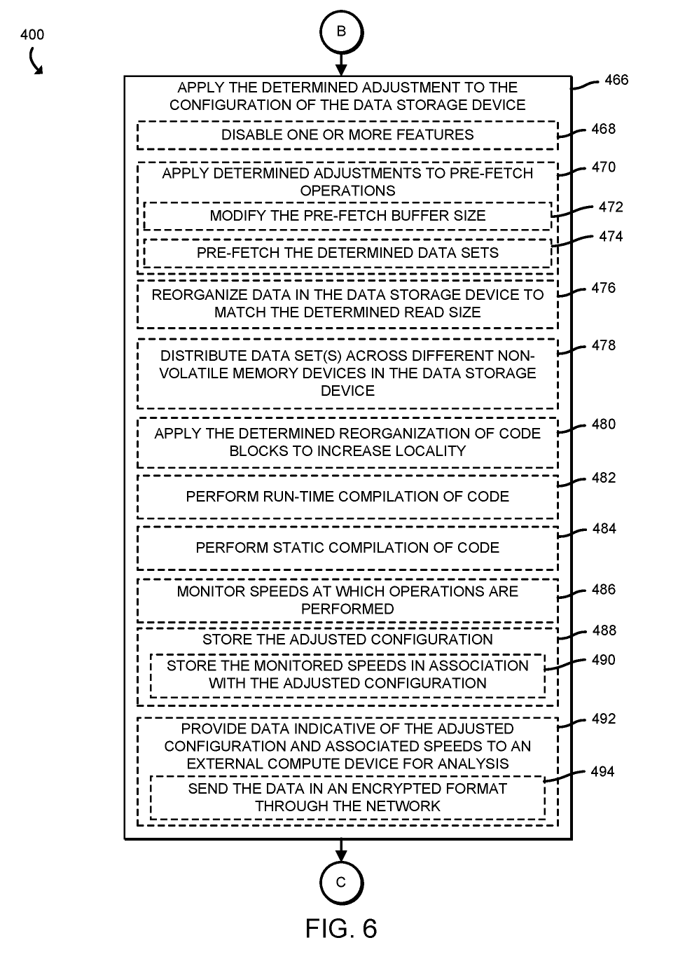

Additionally or alternatively, the data storage device 150 may determine to disable one or more features that were not used by the workload 140, as indicated in block 460. In doing so, the data storage device 150, in the illustrative embodiment, also disables any system checks (e.g., to determine whether components associated with those disabled features are operative) associated with those unused features, as indicated in block 462. Doing so may reduce the amount of code executed by the data storage device during a boot sequence and/or during data access operations (e.g., the data storage device 150 will no longer spend time determining whether a requested data set should be decrypted before sending it to the workload 140 because the cryptography functions of the data storage device 150 were not used by the workload 140 in the past and, accordingly, have been disabled). The data storage device may also determine an adjustment to read sizes (e.g., the workload historically requests data sets that are smaller than a default read size defined in the configuration), as indicated in block 464. Subsequently, the method 400 advances to block 466 of FIG. 6, in which the data storage device 150 applies the determined adjustment to the configuration.

Referring now to FIG. 6, in applying the determined adjustment, the data storage device may disable one or more features (e.g., the feature(s) determined in block 460), as indicated in block 468. Additionally or alternatively, the data storage device 150 may apply determined adjustments to prefetch operations, as indicated in block 470. In doing so, the data storage device 150 may modify the buffer size used for prefetch operations, as indicated in block 472 and may prefetch certain data sets that were identified (e.g., in block 452) for prefetching, as indicated in block 474. The data storage device 150 may additionally or alternatively reorganize data (e.g., relocate portions of data sets to be contiguous) to match the determined read size (e.g., from block 464), as indicated in block 476. As indicated in block 478, the data storage device 150 may distribute data set(s) across multiple non-volatile memory devices (e.g., in the non-volatile memory 316) to increase parallelism of data accesses, as described with reference to block 458 of FIG. 4. The data storage device 150 may also apply the determined reorganization of code blocks to increase the locality of the code blocks (e.g., move code blocks defining frequently used functions closer to each other in memory), as indicated in block 480. In some embodiments, the data storage device 150 may perform run-time (e.g., dynamic) compilation of code to apply the changes to the configuration (e.g., to remove jumps to disabled features, to update addresses for functions that have been moved closer to each other, etc.), as indicated in block 482.

In other embodiments, the data storage device 150 may perform static compilation, as indicated in block 484. As such, in some embodiments, the data storage device 150 may restart before performing any data access operations under the adjusted configuration. Regardless, as indicated in block 486, the data storage device 150 monitors speeds at which the data storage device 150 performs operations for the workload 140 under the adjusted configuration. As indicated in block 488, the data storage device 150 stores the adjusted configuration (e.g., in the non-volatile memory 316). In doing so, and as indicated in block 490, the data storage device 150 stores the monitored speeds in association with the adjusted configuration (e.g., to enable the data storage device 150 to determine which stored configuration provides the greatest speed in a subsequent execution of block 412). In some embodiments, the data storage device 150 may provide data indicative of the adjusted configuration and the associated speeds of the operations performed under the adjusted configuration to an external compute device (e.g., the manufacturer compute device 120) for analysis, as indicated in block 492. In doing so, the data storage device 150 may send the data in an encrypted format (e.g., as encrypted telemetry) to the external compute device through the network 130 (e.g., using the NIC 220). Subsequently (e.g., after a predefined time period, upon request by the compute device 110, upon a reboot of the compute device 110, etc.), the method 400 may loop back to block 402 of FIG. 4 to potentially apply further configuration adjustments.

### Examples

Illustrative examples of the technologies disclosed herein are provided below. An embodiment of the technologies may include any one or more, and any combination of, the examples described below.

Example 1 includes an apparatus comprising a controller to obtain a configuration for one or more features of a data storage device; monitor operations of the data storage device on a memory; determine, as a function of the monitored operations, an adjustment to the configuration to accelerate the performance of one or more of the operations; and apply the determined adjustment to the configuration.

Example 2 includes the subject matter of Example 1, and wherein to monitor operations comprises to identify features used over a predefined time period.

Example 3 includes the subject matter of any of Examples 1 and 2, and wherein the controller is further to track an entrance and exit count associated with addresses of functions executed by the data storage device.

Example 4 includes the subject matter of any of Examples 1-3, and wherein the controller is further to determine a frequency of use of each function of a set of functions of the data storage device; and determine whether the frequency of use for each function satisfies a predefined threshold.

Example 5 includes the subject matter of any of Examples 1-4, and wherein the controller is further to identify a sequence of functions executed by the data storage device.

Example 6 includes the subject matter of any of Examples 1-5, and wherein to apply the determined adjustment comprises to disable a function that does not satisfy a predefined threshold frequency of use over a predefined time period.

Example 7 includes the subject matter of any of Examples 1-6, and wherein to determine the adjustment to the configuration comprises to determine a reorganization of code blocks defining functions executable by the data storage device to increase a locality of the code blocks.

Example 8 includes the subject matter of any of Examples 1-7, and wherein to determine the reorganization of code blocks comprises to determine to move code blocks defining functions that satisfy a predefined threshold frequency of use closer to each other to reduce an access time for the data storage device to execute the code blocks.

Example 9 includes the subject matter of any of Examples 1-8, and wherein the data storage device further comprises the memory and memory includes a set of multiple memory devices; and wherein to determine the reorganization comprises to determine a number of the memory devices to distribute a data set across to increase parallelization of access to the data set.

Example 10 includes the subject matter of any of Examples 1-9, and wherein to monitor operations comprises to determine a pattern of accesses to the data in the memory.

Example 11 includes the subject matter of any of Examples 1-10, and wherein to determine the adjustment comprises to determine an adjustment for data prefetching operations.

Example 12 includes the subject matter of any of Examples 1-11, and wherein to determine an adjustment for data prefetching operations comprises to determine a data set to prefetch from the memory when the data storage device has received a request to read a corresponding data set from the memory.

Example 13 includes the subject matter of any of Examples 1-12, and wherein the controller is further to store the adjusted configuration in the memory for subsequent use.

Example 14 includes the subject matter of any of Examples 1-13, and wherein to obtain the configuration comprises to load, from the memory, a configuration that was previously adjusted by the controller.

Example 15 includes one or more machine-readable storage media comprising a plurality of instructions stored thereon that, in response to being executed, cause a data storage device to obtain a configuration for one or more features of the data storage device; monitor operations of the data storage device on a memory of the data storage device; determine, as a function of the monitored operations, an adjustment to the configuration to accelerate the performance of one or more of the operations; and apply the determined adjustment to the configuration.

Example 16 includes the subject matter of Example 15, and wherein to monitor operations comprises to identify features used over a predefined time period.

Example 17 includes the subject matter of any of Examples 15 and 16, and wherein the plurality of instructions further cause the data storage device to track an entrance and exit count associated with addresses of functions executed by the data storage device.

Example 18 includes the subject matter of any of Examples 15-17, and wherein the plurality of instructions further cause the data storage device to determine a frequency of use of each function of a set of functions of the data storage device; and determine whether the frequency of use for each function satisfies a predefined threshold.

Example 19 includes the subject matter of any of Examples 15-18, and wherein the plurality of instructions further cause the data storage device to identify a sequence of functions executed by the data storage device.

Example 20 includes an apparatus comprising circuitry for obtaining a configuration for one or more features of a data storage device; circuitry for monitoring operations of the data storage device on a memory of the data storage device; means for determining, as a function of the monitored operations, an adjustment to the configuration to accelerate the performance of one or more of the operations; and means for applying the determined adjustment to the configuration.

1. An apparatus comprising:
a controller to:
obtain a configuration for one or more features of a data storage device;
monitor operations of the data storage device on a memory;
determine, as a function of the monitored operations, an adjustment to the configuration to accelerate the performance of one or more of the operations; and
apply the determined adjustment to the configuration.

2. The apparatus of claim 1, wherein to monitor operations comprises to identify features used over a predefined time period.

3. The apparatus of claim 2, wherein the controller is further to track an entrance and exit count associated with addresses of functions executed by the data storage device.

4. The apparatus of claim 2, wherein the controller is further to:
determine a frequency of use of each function of a set of functions of the data storage device; and
determine whether the frequency of use for each function satisfies a predefined threshold.

5. The apparatus of claim 2, wherein the controller is further to identify a sequence of functions executed by the data storage device.

6. The apparatus of claim 1, wherein to apply the determined adjustment comprises to disable a function that does not satisfy a predefined threshold frequency of use over a predefined time period.

7. The apparatus of claim 1, wherein to determine the adjustment to the configuration comprises to determine a reorganization of code blocks defining functions executable by the data storage device to increase a locality of the code blocks.

8. The apparatus of claim 7, wherein to determine the reorganization of code blocks comprises to determine to move code blocks defining functions that satisfy a predefined threshold frequency of use closer to each other to reduce an access time for the data storage device to execute the code blocks.

9. The apparatus of claim 1, wherein the data storage device further comprises the memory and memory includes a set of multiple memory devices; and
wherein to determine the reorganization comprises to determine a number of the memory devices to distribute a data set across to increase parallelization of access to the data set.

10. The apparatus of claim 1, wherein to monitor operations comprises to determine a pattern of accesses to the data in the memory.

11. The apparatus of claim 10, wherein to determine the adjustment comprises to determine an adjustment for data prefetching operations.

12. The apparatus of claim 11, wherein to determine an adjustment for data prefetching operations comprises to determine a data set to prefetch from the memory when the data storage device has received a request to read a corresponding data set from the memory.

13. The apparatus of claim 1, wherein the controller is further to store the adjusted configuration in the memory for subsequent use.

14. The apparatus of claim 1, wherein to obtain the configuration comprises to load, from the memory, a configuration that was previously adjusted by the controller.

15. One or more machine-readable storage media comprising a plurality of instructions stored thereon that, in response to being executed, cause a data storage device to:
obtain a configuration for one or more features of the data storage device;
monitor operations of the data storage device on a memory of the data storage device;
determine, as a function of the monitored operations, an adjustment to the configuration to accelerate the performance of one or more of the operations; and
apply the determined adjustment to the configuration.

16. The one or more machine-readable storage media of claim 15, wherein to monitor operations comprises to identify features used over a predefined time period.

17. The one or more machine-readable storage media of claim 16, wherein the plurality of instructions further cause the data storage device to track an entrance and exit count associated with addresses of functions executed by the data storage device.

18. The one or more machine-readable storage media of claim 16, wherein the plurality of instructions further cause the data storage device to:
determine a frequency of use of each function of a set of functions of the data storage device; and
determine whether the frequency of use for each function satisfies a predefined threshold.

19. The one or more machine-readable storage media of claim 16, wherein the plurality of instructions further cause the data storage device to identify a sequence of functions executed by the data storage device.

20. An apparatus comprising:
circuitry for obtaining a configuration for one or more features of a data storage device;
circuitry for monitoring operations of the data storage device on a memory of the data storage device;
means for determining, as a function of the monitored operations, an adjustment to the configuration to accelerate the performance of one or more of the operations; and
means for applying the determined adjustment to the configuration.
